(19) United States
(12) Patent Application Publication
(10) Pub. No.: US 2022/0164659 A1
(43) Pub. Date: May 26, 2022

(54) Deep Learning Error Minimizing System for Real-Time Generation of Big Data Analysis Models for Mobile App Users and Controlling Method for the Same

(71) Applicant: DREAMFORA CO., LTD., Seoul (KR)

(72) Inventor: Seokmin Song, Seoul (KR)

(21) Appl. No.: 17/593,082

(22) PCT Filed: Mar. 4, 2020
(86) PCT No.: PCT/KR2020/003075

§ 371 Date: Sep. 8, 2021

(30) Foreign Application Priority Data
Mar. 8, 2019 (KR) 10-2019-0027039

(51) Int. Cl. G06N 3/08; G06F 16/28

(52) U.S. Cl. CPC G06N 3/08; G06F 16/283

(57) ABSTRACT

The disclosure provides a deep-learning error minimization system for generating a big data analysis model and a control method thereof, the system including: a smartphone configured to send user's basic setting information input through a mobile application in an activated state via a set path, and display an application response signal corresponding thereto; and a server configured to execute a deep-learning learning on an alternative learning set obtained by grouping a new incremental learning set and a learning set previously stored in a database based on the user's basic setting information received from the mobile application of the smartphone, calculate new pattern result models in real time and store the same in the database, calculate an application response signal that optimally corresponds to the user's basic setting information of the smartphone in the new pattern result models stored in the database, and transmit the same to the smartphone.

### TECHNICAL FIELD

The present disclosure relates to a deep-learning error minimization system for generating a big data analysis model for a mobile application user in real time, and a control method thereof, and more particularly, to a deep-learning error minimization system for generating a big data analysis model for a mobile application user in real time, and a control method thereof, which are capable of increasing a process computational speed and calculating a new pattern result model in real time by setting, as alternative learning set data, the grouped result obtained by grouping, in a predetermined range, only pieces of data correlated with each other among newly-generated learning set data as well as various user's behavior patterns and pieces of user's content consumption pattern data which have been previously collected through a mobile application without executing a full deep-learning reinforcement learning, setting the grouped result to alternative learning set data, and subsequently, executing a deep learning.

### BACKGROUND

In general, Artificial Intelligence (AI) is a technique which realizes the abilities to learn, reason, perceive, comprehend natural languages, and the like of humans through computer programs. In recent years, research and development on technologies and products using such an AI are actively underway in the related industry. Furthermore, interest in an application technology using a machine learning, a deep learning, or the like, which are more concrete techniques of the artificial intelligence, is increasing recently. Major global companies are already commercializing AI techniques and launching related products. Among them, in the case of deep learning, in Korea, SuaLab Company is a representative company, “SuaKit,” which is a deep learning machine vision developed by the SuaLab Company, has attracted a lot of attention from overseas, and is being actively exported to overseas markets, such as Asia and Europe. In order to develop the artificial intelligence-related techniques, a programmer needs to create codes of rules to be executed by the artificial intelligence. Here, the introduced machine learning technique enables the artificial intelligence to learn and make rules by itself. Particularly, in recent years, global companies are expanding the field of application of the machine learning technique. Google that has developed AlphaGo, Amazon, IBM, and the like as leaders in this field have released open-source algorithms. In addition, deep learning is a machine learning program proposed to overcome the limitations of artificial neural networks, and the core of deep learning may be a classification-based prediction. Classification methods of deep learning are two types: one is a supervised learning and the other is an unsupervised learning. The supervised learning is a method of teaching information to a computer first, for example, showing a normal product of a certain product and distinguishing a normal product based on this. In the unsupervised learning, a computer learns a normal product by itself without such a learning process. The unsupervised learning is a more advanced technique than the supervised learning and requires higher computing power of the computer. In deep learning, there are a number of open-source libraries (Google's Tensorflow) for deep-learning reinforcement learning models (Recurrent Neural Network (RNN), DQN of DeepMind Technologies Ltd., and the like). For example, a method using the deep learning model such as Deep Q-Network (DQN) used in AlphaGo and AlphaZero developed by Google DeepMind is widely known.

A method of controlling an artificial intelligence system using the deep learning technique such as the conventional DQN as described above will be described with reference to FIG. 1. First, the control method includes: a first step S100 of connecting hundreds or more computers to each other through a network and analyzing millions of the records of Baduk games over a long period of time (for example, several months); after the first step S100, a second step S101 of generating a new model using the full deep-learning reinforcement learning based on the analysis result; and after the second step S101, a third step S102 of executing the full deep-learning reinforcement learning using the generated new model to obtain additional data, storing the same, and continuously repeating the steps.

However, the method of controlling the artificial intelligence system using the conventional deep learning technique as described above is a method based on an algorithm of analyzing all the accumulated big data. Therefore, when new data is added, very large parallel computing power is necessarily required. This makes it difficult to perform such an analysis in real time, which may cause a problem that there is a Badu significant gap in time between the data analysis time and the service provision time. For example, in the case of the open-sources that use the deep learning technique such as AlphaGo and AlphaZero developed by Google DeepMind, a significant level of computing power and a long-term processing speed are required to enhance the precision of an analysis process. This makes it difficult to update new models in real time.

### SUMMARY

The present disclosure is made to solve the above problem, and an object of the present disclosure is to provide a deep-learning error minimization system for generating a big data analysis model for a mobile application user in real time, and a control method thereof, which are capable of significantly simplifying a calculation process of a deep learning compared to existing pattern data learned with a full deep learning by using an alternative learning set data generated based on a representative value obtained by grouping valves having a correlation with each other, thereby further increasing a computational speed and quickly calculating a pattern result model for newly-input pattern data.

Another object of the present disclosure is to provide a deep-learning error minimization system for generating a big data analysis model for a mobile application user in real time, and a control method thereof, which are capable of being implemented with little computing power by using an algorithm for minimizing an error in establishment of a big data deep learning model, and quickly obtaining a new result model without waiting for an analysis cycle or without a large-capacity parallel computing power by generating and providing a model obtained by updating application data including a mobile application in real time.

According to an embodiment of the present disclosure, there is provided a deep-learning error minimization system for generating a big data analysis model for a mobile application user in real time and a control method thereof, the system including: a smartphone configured to send user's basic setting information (including pattern data) input through a mobile application in an activated state via a set path, and display an application response signal corresponding thereto in the mobile application; and a deep-learning management server configured to execute a deep-learning learning on an alternative learning set obtained by grouping a new incremental learning set and a learning set previously stored in a database based on the user's basic setting information received from the mobile application of the smartphone, calculate new pattern result models in real time and store the same in the database, calculate an application response signal that optimally corresponds to the user's basic setting information of the smartphone in the new pattern result models stored in the database, and transmit the same to the smartphone.

According to another embodiment of the present disclosure, there is provided a method of controlling a deep-learning error minimization system for generating a big data analysis model for a mobile application user in real time, the method comprising: a first step of transmitting user's basic setting information to a deep-learning management server in a state in which a mobile application of a smartphone is activated; after the first step, a second step of allowing a main control module of the deep-learning management server to drive a new incremental learning set generation module so as to digitize the user's basic setting information (including pattern data) transmitted from the mobile application of the activated smartphone, and generate the same as a new incremental learning set; a third step of allowing, during the second step, the main control module of the deep-learning management server to drive the new incremental learning set generation module so as to digitize user's basic setting information (including pattern data) newly received from the mobile application of the smartphone and generate the same as a new incremental learning set, and to drive an alternative learning set generation module so as to group learning sets (all existing learning set in which new pattern result models are accumulated) previously stored in a full-calculation management server with each other by items having a high set correlation coefficient or data having relevance or similarity, to generate and output an alternative learning set; and after the third step, a fourth step of allowing the main control module of the deep-learning management server to drive a final learning set calculation module so as to add the new incremental learning generated by the new incremental learning set generation module and the alternative learning set generated by the alternative learning set generation module to calculate the final learning set, and to drive the deep-learning learning module so as to execute a deep-learning reinforcement learning on the final learning set calculated by the final learning set calculation module to calculate the final new model.

According to the present disclosure, only pieces of data correlated with each other among newly-generated learning set data as well as various user's behavior patterns and pieces of user's content consumption pattern data which have been previously collected through a mobile application are grouped in a certain range without executing a full deep-learning reinforcement learning to be set as an alternative learning set. Subsequently, a deep learning is executed to calculate a new pattern result model in real time. Thus, the present disclosure has a configuration in which the alternative learning set data grouped on the basis of correlation is generated using a representative value thereof. Thus, it is possible to significantly simplify a calculation process of a deep learning compared to existing pattern data learned with a full deep learning, thereby further increasing a computational speed and quickly calculating a pattern result model for newly-input pattern data.

Furthermore, the present disclosure is implemented with little computing power by using an algorithm for minimizing an error in establishment of a big data deep learning model. Thus, by generating and providing a model obtained by updating application data including a mobile application in real time, it is possible to quickly obtain a new result model without waiting for an analysis cycle or without a large-capacity parallel computing power.

### BRIEF DESCRIPTION OF THE DRAWINGS

FIG. 1 is an explanatory view illustrating an example of an artificial intelligence system using a conventional deep learning.

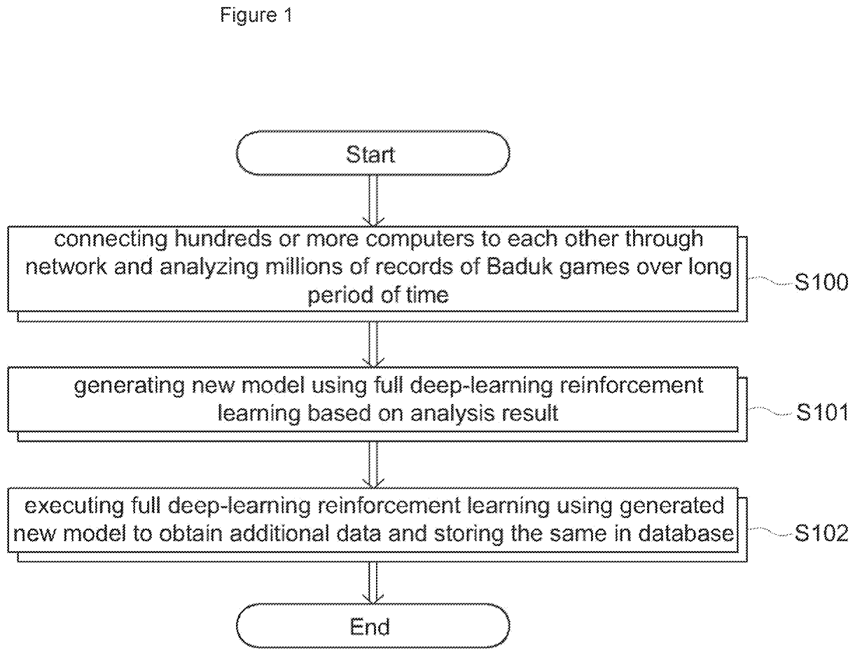

FIG. 2 is an explanatory view illustrating an example of a deep-learning error minimization system for generating a big data analysis model for a mobile application user in real time according to the present disclosure.

FIG. 3 is an explanatory view schematically illustrating a method of calculating a new model in the deep-learning error minimization system of FIG. 2.

FIG. 4 is an explanatory view illustrating a process performed in a deep-learning management server in the deep-learning error minimization system of FIG. 2.

FIG. 5 is an explanatory view schematically illustrating a process of a final evaluation module in the deep-learning error minimization system of FIG. 2.

FIG. 6 is a flowchart for explaining a control method according to the present disclosure.

### DETAILED DESCRIPTION

The present disclosure may be embodied in a variety of other forms and may have various embodiments. Specific embodiments will be described in detail with reference to the accompanying drawings. However, the present disclosure is not limited to the specific embodiments, and may include all modifications, equivalents, or substitutions included in the spirit and scope of the present disclosure. In the following, a detailed description of the related art, which deviate from the gist of the present disclosure, will be omitted.

Terms “first,” “second,” and the like are used to distinguish a plurality of various constituent elements, but the present disclosure is not limited by these terms. The terms may be used to distinguish one constituent element from another.

Terms described herein are used merely to describe specific embodiments and are not intended to limit the present disclosure. The singular form described herein may include the plural form unless the context clearly dictates otherwise. Terms “comprising,” “including,” “having,” and the like are intended to describe a feature, a number, a step, an operation, a constituent element, a part, or a combination thereof in the specification, but may be intended to include one or more other features, numbers, steps, operations, constituent elements, parts, or a combination thereof.

When the present disclosure is described, if it is determined that a detailed description of the related art unnecessarily deviates from the gist of the present disclosure, the detailed description thereof will be omitted.

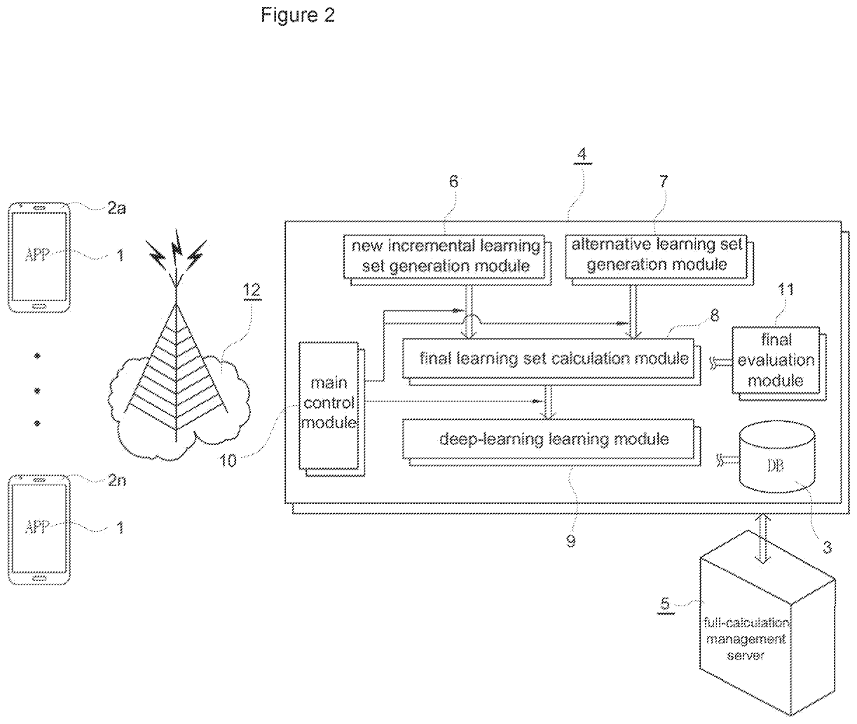

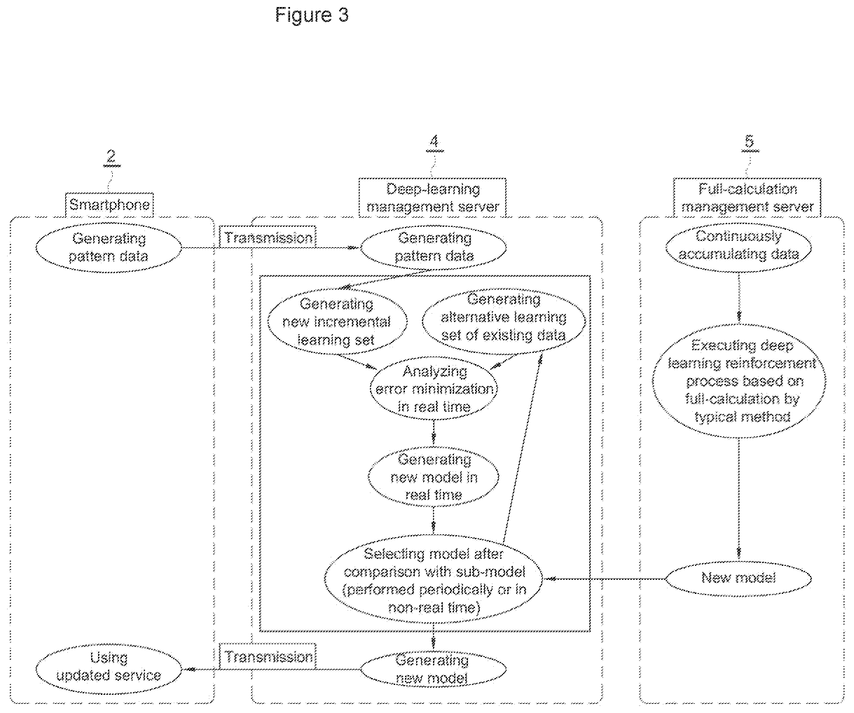

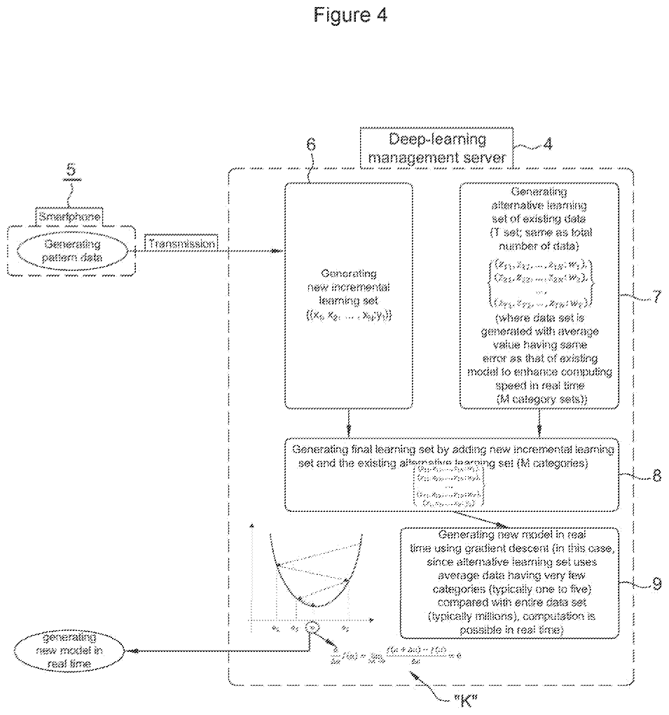

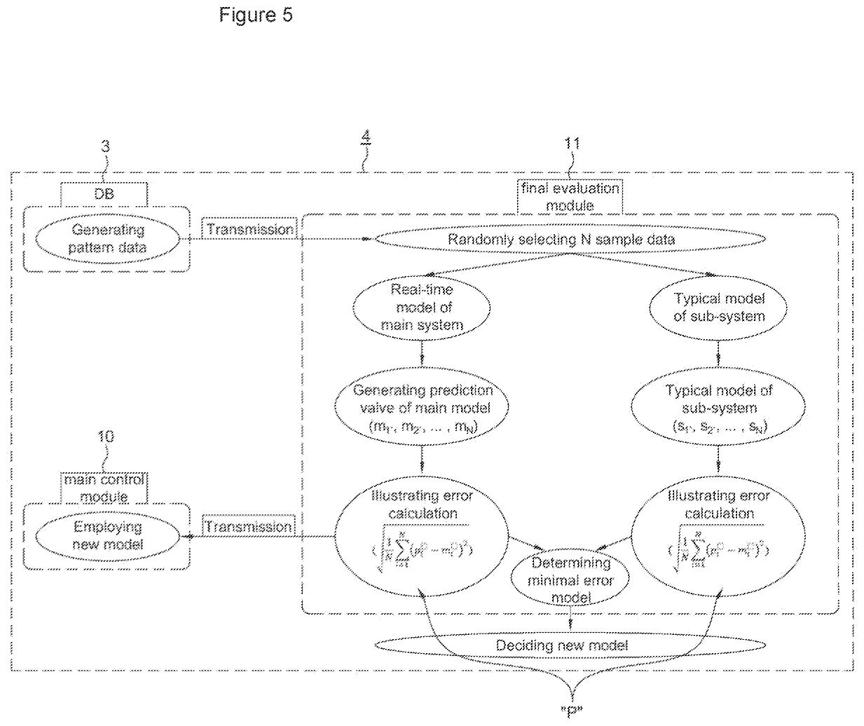

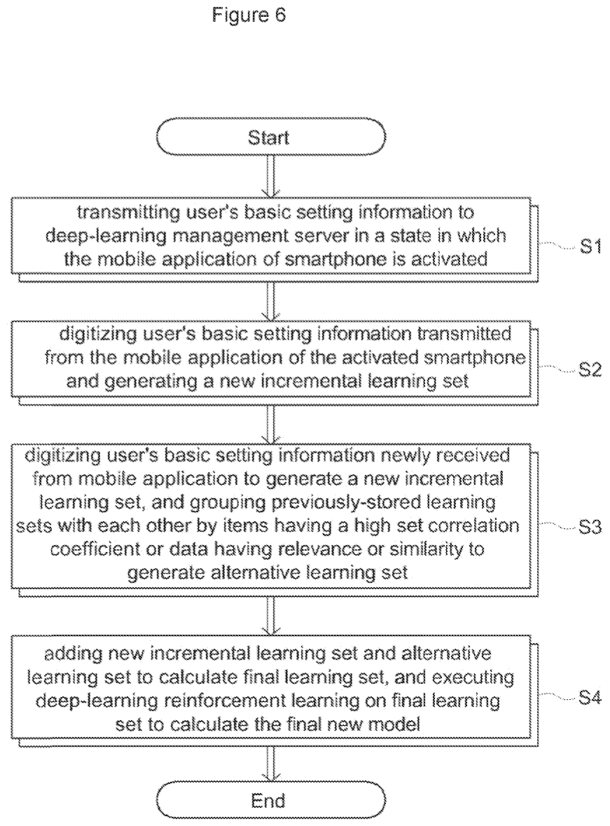

Embodiments of the present disclosure will be described in detail below with reference to the drawings. FIG. 2 is an explanatory view illustrating an example of a deep-learning error minimization system for generating a big data analysis model for a mobile application user in real time according to the present disclosure, FIG. 3 is an explanatory view schematically illustrating a method of calculating a new model in the deep-learning error minimization system of FIG. 2, FIG. 4 is an explanatory view illustrating a process performed in a deep-learning management server in the deep-learning error minimization system of FIG. 2, FIG. 5 is an explanatory view schematically illustrating a process performed by a final evaluation module in the deep-learning error minimization system of FIG. 2, and FIG. 6 is a flowchart for explaining a control method according to the present disclosure.

As illustrated in FIG. 2, the deep-learning error minimization system according to the present disclosure includes: a plurality of smartphones 2a to 2n, each configured to send basic setting information (including pattern data) input through a mobile application 1 in an activated state, for example, a goal achievement planning application, via a set path, and display an application response signal corresponding thereto in the mobile application 1; and a deep-learning management server 4 configured to execute a deep learning on an alternative learning set obtained by grouping a new incremental learning set and a learning set previously stored in a database (DB) 3 based on the basic setting information received from the mobile application 1 of the smartphone 2a, . . . , or 2n to calculate new pattern result models in real time and store the same in the DB 3, calculate an application response signal in the DB 3 in which the new pattern result models are stored that optimally corresponds to the basic setting information of the smartphone 2a, . . . , or 2n, and transmit the same to the smartphone 2a, . . . , or 2n.

In an embodiment, the deep-learning management server 4 further includes a full-calculation management server 5 configured to continuously accumulate all new pattern result models newly generated every time the new pattern result models are generated, execute a deep-learning reinforcement learning on the accumulated pattern result models to generate a new pattern result model, and store the same in the DB 3.

In an embodiment, as illustrated in FIGS. 3 to 5, the deep-learning management server 4 further includes: a new incremental learning set generation module 6 configured to digitize the user's basic setting information (including pattern data) newly received from the mobile application 1 of the smartphone 2a, . . . , or 2n so as to generate and output a new incremental learning set; an alternative learning set generation module 7 configured to generate and output an alternative learning set by grouping learning sets (all existing learning sets in which the new pattern result models are accumulated) previously stored in the full-calculation management server 5 with each other by items having a high set correlation coefficient or data with relevance or similarity; a final learning set calculation module 8 configured to calculate a final learning set by adding the new incremental learning set from the new incremental learning set generation module 6 and the alternative learning set from the alternative learning set generation module 7; a deep-learning learning module 9 configured to execute the deep-learning reinforcement learning on the final learning set calculated by the final learning set calculation module 8 to calculate a final new model; and a main control module 10 configured to control functions of the deep-learning management server 4 as well as the deep-learning learning module 9 and the like according to a set operating program.

In an embodiment, the deep-learning management server 4 further includes a final evaluation module 11 configured to compare and verify the final new model generated by the deep-learning learning module 9 with actual data obtained by randomly sampling the new pattern result models generated through the deep-learning reinforcement learning using the full-calculation management server 5 using the final new model and the randomly-sampled actual data, set a new model having the smallest error as a best new model, and transmit the same to the deep-learning management server 4, under the functional control of the main control module 10.

Further, under the functional control of the main control module 10, the deep-learning management server 4 sends, as an application response signal, the best new model calculated by the final evaluation module 11 to the mobile application 1 of the smartphone 2a, . . . , or 2n which requests a response. Thus, the best new model is displayed in the smartphone.

Here, the deep-learning learning module 9 uses a gradient descent (GD) algorithm that utilizes a representative value in a process of calculating the final new model by executing the deep-learning reinforcement learning on the final learning set calculated by the final learning set calculation module 8. A mathematical formula which exemplifies the gradient descent algorithm uses the mathematical formula indicated by “K” in FIG. 4, and the gradient descent algorithm as described above is an optimization algorithm for finding a first-order approximate value. The basic idea of the gradient descent algorithm is to obtain a gradient (slope) of a function, continuously move a value toward a lower value of the gradient (slope), and iteratively execute the movement until the value reaches a lowest value. The gradient descent algorithm (GD) averages the slope of the all sample data and iteratively adjusts parameters to minimize a cost function. The gradient descent algorithm according to the present disclosure may be configured of a neural network circuit of the deep learning. Thus, when the gradient descent algorithm of the present disclosure as described above is used, the alternative learning set grouped by the alternative learning set generation module 7 in the before step uses an extremely small amount of representative data compared to the entire data set calculated by the full-calculation management server 5. This makes it possible to perform calculation in real time.

In an embodiment, the final evaluation module 11 uses the least squares algorithm in a process of setting the new model having the smallest error as the best new model by comparing and verifying the actual new pattern result models stored in the DB 3 with randomly-sampled actual data among the actual new pattern result model stored in the DB 3 using the randomly-sampled actual data. A mathematical formula which exemplifies the least squares algorithm uses the mathematical formula indicated by “P” in FIG. 5. The least squares algorithm as described above squares an error to obtain a minimum value. For example, in a case in which certain data is expressed on a linear graph, a plurality of values may be unevenly distributed. Thus, the least squares algorithm arbitrarily draws a line, sets values that deviate away from the line as errors, squares such errors, obtains the sum of all the squared values, and obtains a minimum. That is, for one independent variable x and one dependent variable Y, experimental data thereof takes the form of a paired sequence (xi, yj). A regression line suitable for a set of the experimental data may be easily obtained by the least squares algorithm. First, \textcircled{1} in order to minimize a sum of the squares of distances (in a y-axis direction and a vertical direction) of points (xi, yj) spaced apart from a line, the regression line is set to be suitable for the points. \textcircled{2} A perpendicular distance (in the y-axis direction) from the line to the experimental data (xi, yj) is set. \textcircled{3} A sum of the squares of the distances is set to q (where a (coefficient) and b (constant) are set so that q is minimized).

Therefore, in view of the forgoing, in an example of the least squares algorithm, when the regression line is expressed by y=a+bx, a model having the coefficient “a” and the constant “b” with which the sum of the squares of the distances as follows is minimized,

$$q = {\sum }_{j - 1}^{N} {( {y}_{j} - a - b {x}_{j} )}^{2}$$

is determined as a best model.

Thus, in the present disclosure, by additionally using the least squares algorithm as described above, it is possible to find a model with the smallest error using a mathematical formula of the root mean square error as indicated by “P” in FIG. 5.

$$\sqrt{\frac{1}{N} {\sum }_{i = 1}^{N} {( {p}_{i} - {m}_{i} )}^{2}}$$

A control method of the present disclosure configured as above will be described below.

As illustrated in FIG. 6, the control method of the present disclosure includes: a first step S1 of transmitting the user's basic setting information to the deep-learning management server 4 in a state in which the mobile application 1 of the smartphone 2a, . . . , or 2n is activated; after the first step S1, a second step S2 of allowing the main control module 10 of the deep-learning management server 4 to drive the new incremental learning set generation module 6 so as to digitize the user's basic setting information (including pattern data) transmitted from the mobile application 1 of the activated smartphone 2a, . . . , or 2n, and generate the same as a new incremental learning set; a third step S3 of allowing, during the second step S2, the main control module 10 of the deep-learning management server 4 to drive the new incremental learning set generation module 6 so as to digitize user's basic setting information (including pattern data) newly received from the mobile application 1 of the smartphone 2a, . . . , or 2n and generate the same as a new incremental learning set, and to drive the alternative learning set generation module 7 so as to group the learning sets (all existing learning set in which the new pattern result models are accumulated) previously stored in the full-calculation management server 5 with each other by items having a high set correlation coefficient or data having relevance or similarity, to generate and output the alternative learning set; and after the third step S3, a fourth step S4 of allowing the main control module 10 of the deep-learning management server 4 to drive the final learning set calculation module 8 so as to add the new incremental learning generated by the new incremental learning set generation module 6 and the alternative learning set generated by the alternative learning set generation module 7 to calculate the final learning set, and to drive the deep-learning learning module 9 so as to execute the deep-learning reinforcement process on the final learning set calculated by the final learning set calculation module 8 to calculate the final new model.

In an embodiment, the third step S3 further includes a step of allowing the main control module 10 of the deep-learning management server 4 to drive the full-calculation management server 5 so as to continuously accumulate all new pattern result models newly generated every time the new pattern result models are generated, and execute the deep-learning reinforcement learning on all the accumulated pattern result models, thus generating and storing the new pattern result models.

In an embodiment, the fourth step S4 further includes a best new model generation step of allowing the main control module 10 of the deep-learning management server 4 to drive the final evaluation module 11 so as to compare and verify the final new model generated by the deep-learning learning module 9 and the new models generated by executing the full deep-learning reinforcement learning on the new pattern result models by the full-calculation management server 5 with the randomly-sampled actual data using the randomly-sampled actual data among the final new model generated by the deep-learning learning module 9 and the new models generated by executing the full deep-learning reinforcement learning on the new pattern result models by the full-calculation management server 5, set one having the smallest error among the models as the best new model, and send the same to the deep-learning management server 4.

In another embodiment, the fourth step S4 further includes a step in which the deep-learning learning module 9 uses the gradient descent algorithm that utilizes a representative value in calculating the final new model by executing the deep-learning reinforcement learning on the calculated final learning set, thereby enhancing a computing calculation speed.

In an embodiment, the best new model generation step further includes a minimum error determination step of allowing the final evaluation module 11 to use the least squares algorithm in setting one with the smallest error among the actual new modes as the best new model by comparing and verifying the actual new models with randomly-sampled actual data among the actual new models using the randomly-sampled actual data.

In other words, when the user activates the mobile application 1, for example, the goal achievement planning application on his/her own smartphone 2a, . . . , or 2n and inputs user's basic setting information (including pattern data), such as gender, age, nationality, occupation, alma mater, dream, habit, goal to be achieved, or the like on a default screen of the mobile application 1, the mobile application 1 transmits the user's basic setting information to the deep-learning management server 4 via a wireless Internet network 12. Thereafter, the main control module 10 of the deep-learning management server 4 drives the new incremental learning set generation module 6 to digitize the user's basic setting information (including pattern data) transmitted from the mobile application 1 of the smartphone 2a, . . . , or 2n, generate a new incremental learning set, and then output the same to the final learning set calculation module 8 as described above. In addition, in parallel with the above operation, the main control module 10 of the deep-learning management server 4 drives the alternative learning set generation module 7 to group the learning sets (all existing learning sets in which the new pattern result models are accumulated) previously stored in the full-calculation management server 5 with each other by items having a high set correlation coefficient or data having relevance or similarity, to generate the alternative learning set and output the same to the final learning set calculation module 8.

In some embodiments, after the calculation operation described above, the main control module 10 of the deep-learning management server 4 drives the final learning set calculation module 8 to add the new incremental learning set generated by the new incremental learning set generation module 6 and the alternative learning set generated by the alternative learning set generation module 7 to generate the final learning set, and subsequently, drives the deep-learning learning module 9 to execute the deep-learning reinforcement process on the final learning set calculated by the final learning set calculation module 8 to generate the final model.

In some embodiments, during the calculation operation described above, the main control module 10 of the deep-learning management server 4 additionally drives the full-calculation management server 5 to continuously accumulate all new pattern result models newly generated every time the new pattern result models are generated, execute the deep-learning reinforcement process on all the accumulated pattern result models to generate and store a new pattern result model, and then send the same to the deep-learning management server 4. Further, during the calculation operation, the main control module 10 of the deep-learning management server 4 drives the final evaluation module 11 to compare and verify the final new model generated by the deep learning module 9 and the new models generated by executing the deep-learning reinforcement process by the full-calculation management server 5 with the randomly-sampled actual data using the randomly-sampled actual data among the final new model generated by the deep-learning learning module 9 and the new models generated by executing the deep-learning reinforcement learning by the full-calculation management server 5, set one with the smallest error among the new models as the best new model, and send the same to the deep-learning management server 4.

Subsequently, under the functional control of the main control module 10, the deep-learning management server 4 sends the best new model calculated by the final evaluation module 11 as the application response signal to the mobile application 1 of the respective smartphone 2a, . . . , or 2n.

Further, when executing the deep-learning reinforcement process on the final learning set calculated as above to generate the final new model, the deep-learning learning module 9 uses the gradient descent algorithm indicated by “K” in FIG. 4 using representative data having the same error but requires a reduced computational complexity compared with the actual data as described in a section indicated by reference numeral “7” in FIG. 4. This makes it possible to implement a real time calculation.

Further, when comparing and verifying the actual new models with randomly-sampled actual data among the actual new models using the randomly-sampled actual data and setting one with the smallest error among the models as the best new model in the above manner, the final evaluation module 11 uses the least squares algorithm indicated by “P” in FIG. 5. This makes it possible to find the new model with the smallest error compared with the case of the actual data.

### EXPLANATION OF REFERENCE NUMERALS

1: mobile application
2a to 2n: smartphone
3: database (DB)
4: deep-learning management server
5: full-calculation management server
6: new incremental learning set generation module
7: alternative learning set generation module
8: final learning set calculation module
9: deep-learning learning module
10: main control module
11: final evaluation module
12: wireless Internet network

What is claimed is:

1-11. (canceled)

12. A deep-learning error minimization system for generating a user's big data analysis model in real time, comprising:
a deep learning management server configured to: receive user's basic setting information including a user's behavior pattern and user's content consumption pattern data from a user' smartphone; execute a deep-learning learning on an alternative learning set obtained by grouping a new incremental learning set and a learning set previously stored in a database based on the user's basic setting information; calculate new pattern result models in real time and store the calculated new pattern result models in the database; calculate an application response signal corresponding to a best new model that optimally corresponds to the user's basic setting information from the stored new pattern result models, and transmit the application response signal to the user's smartphone; and a full-calculation management server configured to continuously accumulate all new pattern result models newly generated every time the new pattern result models are generated, execute a deep-learning reinforcement learning on the all accumulated pattern result models to generate a new pattern result model, and store the new pattern result model in the database,
wherein the deep learning management server calculates a final learning set by adding the new incremental learning set and the alternative learning set, execute the deep-learning reinforcement learning on the final learning set to calculate a final new model, compare and verify the final new model with randomly-sampled actual data among actual new models generated through the deep-learning reinforcement learning using the full-calculation management server using the final new model and the randomly-sampled actual data, set a new model having the smallest error among the models as the best new model.

13. The deep-learning error minimization system of claim 12, wherein the deep-learning management server includes:
a new incremental learning set generation module configured to digitize the user's basic setting information to generate and output a new incremental learning set;
an alternative learning set generation module configured to generate and output the alternative learning set by grouping learning sets including all previously-stored learning sets in which the new pattern result models are accumulated, which are previously stored in the full-calculation management server, with each other by items having a high set correlation coefficient or data with relevance or similarity;
a final learning set calculation module configured to calculate the final learning set by adding the new incremental learning set and the alternative learning set;
a deep learning module configured to execute the deep-learning reinforcement learning on the final learning set to calculate the final new model; and
a main control module configured to control the new incremental learning set generation module, the alternative learning set generation module, the final learning set calculation module, and the deep learning module based on a set operating program.

14. The deep-learning error minimization system of claim 13, wherein the deep-learning module uses a gradient descent algorithm that utilizes a representative data in calculating the final new model by executing the deep-learning reinforcement learning on the final learning set calculated by the final learning set calculation module.

15. The deep-learning error minimization system of claim 12, wherein the deep-learning management server uses a least squares algorithm to set the best new model.

16. A method of generating a big data analysis model for a mobile application user in real time, the method comprising:
a first step of receiving, by a deep learning management server, user's basic setting information including a user's behavior pattern and user's content consumption pattern data; after the first step, a second step of digitizing, by the deep learning management server, the user's basic setting information to generate a new incremental learning set;
a third step of grouping, by the deep learning management server, the new incremental learning set and all previously-stored learning sets in which new pattern result models are accumulated, which are previously stored in a full-calculation management server, with each other by items having a high set correlation coefficient or data having relevance or similarity, based on the user's basic setting information, to generate and output an alternative learning set; and
after the third step, a fourth step of adding, by the deep learning management server, the new incremental learning and the alternative learning set to calculate a final learning set, followed by executing a deep-learning reinforcement learning on the final learning set to calculate a final new model,
wherein the third step further includes a step of allowing the deep learning management server to continuously accumulate all new pattern result models newly generated every time the new pattern result models are generated, and execute the deep-learning reinforcement learning on the accumulated new pattern result models, generate and store new pattern result models.

17. The method of claim 16, wherein the fourth step further includes a step of comparing and verifying the final new model and randomly-sampled actual data among the actual new models using the final new model and the randomly-sampled actual data, setting a new model having the smallest error among the models as a best new model.

18. The method of claim 16, wherein the fourth step further includes a step of allowing the deep learning module to use a gradient descent algorithm that utilizes a representative data in calculating the final new model by executing the deep-learning reinforcement process on the calculated final learning set.

19. The method of claim 16, wherein the step of generating the best new model further includes a minimum error determination step of using a least squares algorithm in generating the best new model.
